(19) United States
(12) Patent Application Publication
(10) Pub. No.: US 2017/0052484 A1
(43) Pub. Date: Feb. 23, 2017

(54) TRANSFER DEVICE AND IMAGE FORMING APPARATUS

(71) Applicant: FUJI XEROX CO., LTD., Tokyo (JP)

(72) Inventors: Motoki MATSUSHIMA, Kanagawa (JP); Yoshinori TAKAHASHI, Kanagawa (JP); Yuki NAGAMORI, Kanagawa (JP)

(73) Assignee: FUJI XEROX CO., LTD., Tokyo (JP)

(21) Appl. No.: 14/980,828

(22) Filed: Dec. 28, 2015

(30) Foreign Application Priority Data
Aug. 19, 2015 (JP) 2015-161913

(51) Int. Cl. G03G 15/16

(52) U.S. Cl. CPC G03G 15/167

(57) ABSTRACT

Provided is a transfer device including a transfer roller that forms a nip portion between the transfer roller and an image holding member and transfers a toner image on the image holding member to a recording medium, and a transporting unit that transports the recording medium so that a leading end of the recording medium in a transport direction is brought into contact with the transfer roller and is then transported into the nip portion, when a portion of the toner image on the image holding member is transferred to a region that includes a leading edge of the recording medium in the transport direction.

### CROSS-REFERENCE TO RELATED APPLICATIONS

This application is based on and claims priority under 35 USC 119 from Japanese Patent Application No. 2015-161913 filed Aug. 19, 2015.

### BACKGROUND

### Technical Field

The present invention relates to a transfer device and an image forming apparatus.

### SUMMARY

According to an aspect of the invention, there is provided a transfer device including

a transfer roller that forms a nip portion between the transfer roller and an image holding member and transfers a toner image on the image holding member to a recording medium; and

a transporting unit that transports the recording medium so that a leading end of the recording medium in a transport direction is brought into contact with the transfer roller and is then transported into the nip portion, when a portion of the toner image on the image holding member is transferred to a region that includes a leading edge of the recording medium in the transport direction.

### BRIEF DESCRIPTION OF THE DRAWINGS

Exemplary embodiments of the present invention will be described in detail based on the following figures, wherein:

FIG. 1 is a configuration diagram illustrating an image forming apparatus to which a transfer device according to a first exemplary embodiment of the present invention is applied;

FIG. 2 is a front view illustrating the transfer device applied to the image forming apparatus illustrated in FIG. 1;

FIG. 3 is a front view illustrating a range in which a recording medium is brought into contact with a transfer roller side in the transfer device illustrated in FIG. 2;

FIG. 4 is a front view illustrating the state of the recording medium when a peripheral speed ratio of the transfer roller with respect to a transfer belt is reduced, in the transfer device illustrated in FIG. 2;

FIG. 5 is a front view illustrating a transfer device according to a second exemplary embodiment of the present invention;

FIG. 6 is a front view illustrating a transfer device according to a third exemplary embodiment of the present invention;

FIG. 7 is a front view illustrating a transfer device according to a fourth exemplary embodiment of the present invention;

FIG. 8 is a front view illustrating a transfer device according to a fifth exemplary embodiment of the present invention;

FIG. 9 is a front view illustrating a transfer device according to an example of the present invention;

FIG. 10 is a graph illustrating a relationship between a toner stain on a tip face of paper in a transport direction and a distance at which a tip portion of the paper in the transport direction is moved to a transfer roller side, in the transfer device illustrated in FIG. 9;

FIG. 11 is a diagram illustrating states of a toner stain on a tip face of paper in a transport direction which are indicated by G1 to G5 in a stepwise manner;

FIG. 12 is a schematic diagram illustrating a state where a tip face of paper in a transport direction scrapes off a toner image of a transfer belt when the toner image on the transfer belt is transferred to the paper using a transfer device according to a comparative example; and

FIG. 13 is a graph illustrating a relationship between a toner stain on a tip face of paper in a transport direction and a peripheral speed ratio of a transfer roller with respect to a transfer belt, and a graph illustrating a relationship between the image reduction of a toner image transferred to the paper and the peripheral speed ratio of the transfer roller with respect to the transfer belt.

### DETAILED DESCRIPTION

Hereinafter, exemplary embodiments of the present invention will be described with reference to the accompanying drawings.

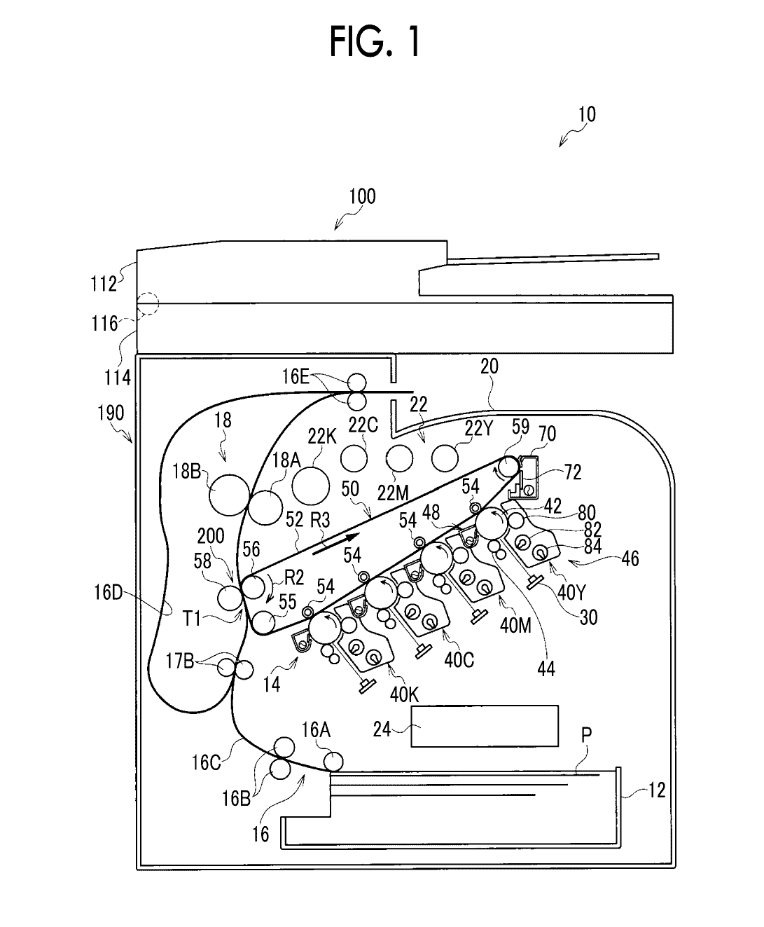

FIG. 1 is a diagram illustrating an example of a configuration of an image forming apparatus 10 to which a transfer device according to a first exemplary embodiment of the present invention is applied. As illustrated in FIG. 1, the image forming apparatus 10 includes an image reading section 100 that outputs an image of a document as read image data, and an image forming section 190 that forms an image on a recording medium based on the image data. The image reading section 100 includes a document transport section 112 and a document reading section 114, and the document transport section 112 is provided above the document reading section 114 so as to be openable and closable centering on a connection section 116.

The image forming section 190 is configured to include a paper accommodating section 12 that accommodates paper P as a recording medium, a toner image forming section 14, a transport section 16, a fixing device 18, a discharge section 20, a supply mechanism 22, and a controller 24.

The toner image forming section 14 includes image forming units 40Y, 40M, 40C, and 40K, and a transfer unit 50. Each of the image forming units 40Y, 40M, 40C, and 40K includes an image holding member 42, a charging device 44, an exposing device 30, a developing device 46, and a removing device 48. In each of the image forming units 40Y, 40M, 40C, and 40K, each of toner images of yellow (Y), magenta (M), cyan (C), and black (K) colors is formed on the outer circumferential surface of each of the respective image holding members 42.

The charging device 44 charges the outer circumferential surface of the image holding member 42. The exposing device forms a latent image by irradiating the outer circumferential surface of the image holding member 42 charged by the charging device 44 with exposure light. In addition, the developing device 46 develops the latent image formed on the image holding member 42 as a toner image. The developing device 46 includes a toner supply body 80 that supplies a toner to the outer circumferential surface of the image holding member 42, two transport members 82 that transports a toner and a developer including carriers to the toner supply body 80, and a transport member 84. Further, after a toner image formed on the outer circumferential surface of the image holding member 42 is primarily transferred to a transfer belt 52 as an example of an image holding member, the removing device 48 removes a toner remaining on the outer circumferential surface of the image holding member 42 without being primarily transferred, an external additive, and the like from the outer circumferential surface of the image holding member 42.

After a toner image of each color developed on the outer circumferential surface of the image holding member 42 by the developing device 46 is primarily transferred, the transfer unit 50 secondarily transfers the toner image on paper P. The transfer unit 50 includes the transfer belt 52, primary transfer rollers 54 of respective colors, the driving roller 56, and a transfer roller (secondary transfer roller) 58 that constitutes a portion of a transfer device 200. Meanwhile, the transfer device 200 will be described later.

The transfer belt 52 is configured as an endless belt. The primary transfer roller 54 and the driving roller 56 are disposed so as to come into contact with the inner circumferential surface of the transfer belt 52. The posture of the transfer belt 52 is determined by four rollers of the primary transfer roller 54, a supporting roller 55, the driving roller 56, and a tension applying roller 59 which come into contact with the inner circumferential surface thereof. The outer circumferential surface of each of the image holding members 42 constituting the image forming units 40Y, 40M, 40C, and 40K comes into contact with the outer circumferential surface of the transfer belt 52 facing the lower side of the device in a height direction in the transfer unit 50. Meanwhile, the transfer belt 52 is given tension by the tension applying roller 59 which is pressed by a pressing unit (not shown).

The driving roller 56 is configured as a long roller, and the inner circumferential surface of the transfer belt 52 is wound around a portion of the outer circumferential surface of the driving roller 56. When the driving roller 56 is rotated (rotated in a direction of an arrow R2) by a driving source (not shown), the driving roller 56 applies a frictional force to a portion of the transfer belt 52 which is wound around the outer circumferential surface of the driving roller 56. The driving roller 56 rotates the transfer belt 52 in a direction of an arrow R3. The driving roller 56 has a function to rotates the transfer belt 52 and a function as a backup roller of the transfer roller 58 that secondarily transfers a toner image, primarily transferred to the outer circumferential surface of the transfer belt 52, to paper P.

The primary transfer roller 54 primarily transfers a toner image formed on the outer circumferential surface of each of the image holding members 42 to the outer circumferential surface of the transfer belt 52 by a primary transfer voltage applied thereto.

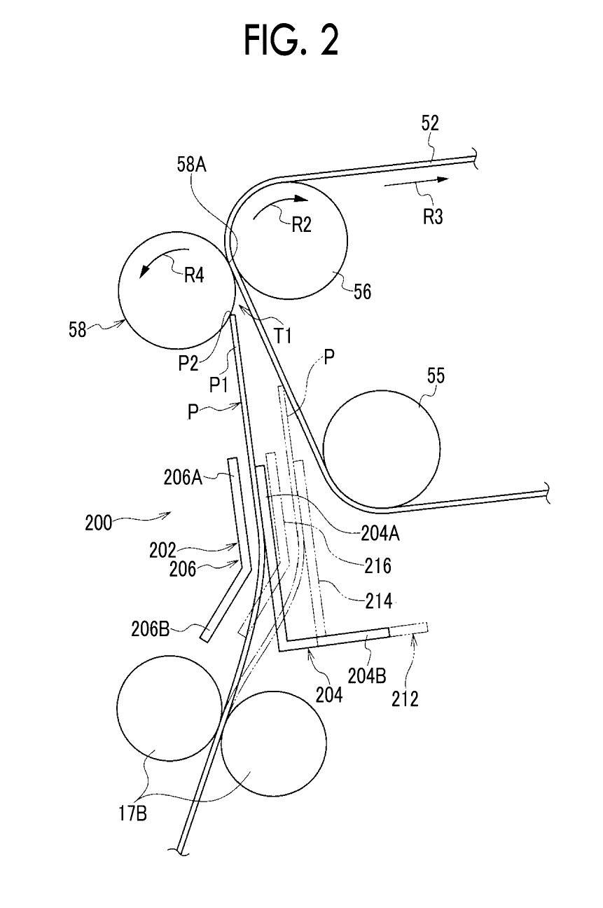

The transfer roller (secondary transfer roller) 58 is configured as a long roller. The transfer roller 58 is pressed against the driving roller 56 side through the transfer belt 52 by a pressing unit (not shown) during an image forming operation. That is, the transfer roller 58 is pressed against the transfer belt 52 to thereby form a nip portion 58A (see FIG. 2), and a position where the nip portion 58A is formed serves as a secondary transfer position T1. The transfer roller 58 is configured to move in the same direction as the transfer belt 52 by the nip portion 58A, and is rotated in a direction of an arrow R4 (see FIG. 2). In the present exemplary embodiment, the transfer roller 58 is configured to be rotated independently of the driving roller 56 by a driving source (not shown). The transfer roller 58 secondarily transfers a toner image, primarily transferred to the outer circumferential surface of the transfer belt 52 and transported along a transport path 16C, to the paper P passing through the secondary transfer position T1 by a secondary transfer voltage applied thereto. Meanwhile, the secondary transfer voltage is a voltage applied to the transfer roller 58 during secondary transfer, and is determined by the controller 24.

After the toner image on the outer circumferential surface of the transfer belt 52 is secondarily transferred to the paper P, a cleaning device 70 removes a toner remaining on the outer circumferential surface of the transfer belt 52 without being secondarily transferred, an external additive, and the like from the outer circumferential surface of the transfer belt 52 by a scraping section 72. Meanwhile, each of supply mechanisms 22Y, 22M, 22C, and 22K supplies a developer to the developing device 46 of each of the respective image forming units 40Y, 40M, 40C, and 40K.

The transport section 16 transports the paper P accommodated in the paper accommodating section 12 to the discharge section 20. The transport section 16 includes a sending-out roller 16A, plural transport roller pairs 16B and 17B, a reversal transport section 16D, and a discharge roller 16E. The sending-out roller 16A sends out the pieces of paper P accommodated in the paper accommodating section 12 one by one. The plural transport roller pairs 16B are disposed along the transport path 16C through which the paper P is transported, and transport the paper P sent out by the sending-out roller 16A to the secondary transfer position T1 at which the driving roller 56 and the transfer roller 58 face each other.

In addition, the transport section 16 is provided with the reversal transport section 16D that reverses the front and back sides of the paper P and transports the paper P so as to be able to form an image on both surfaces of the paper P. The reversal transport section 16D switches back the paper P having a toner image fixed onto the surface thereof. Thereafter, the reversal transport section 16D transports the paper P to the secondary transfer position T1 so that the rear surface of the paper P faces the outer circumferential surface of the transfer belt 52.

The fixing device 18 is disposed on a downstream side of the paper P in the transport direction with respect to the secondary transfer position T1. The fixing device 18 includes a fixing roller 18A and a pressing roller 18B, and fixes a toner image, which is secondarily transferred to the paper P, to the paper P.

The discharge section 20 is located closer to the downstream side of the paper P in the transport direction than the fixing device 18, and is formed on a portion of an outer upper surface of the body of the image forming section 190. The paper P having the toner image fixed thereto by the fixing device 18 is discharged to the discharge section 20 by the discharge roller 16E.

Next, an image forming operation in the image forming section 190 will be described with reference to FIG. 1.

The outer circumferential surface of the image holding member 42 which is charged by the charging device 44 is irradiated with exposure light emitted from the exposing device 30 in accordance with image data of each color, and thus a latent image corresponding to the image data of each color is formed on the outer circumferential surface of each of the image holding members 42. The latent image formed on the outer circumferential surface of each of the image holding members 42 is developed as a toner image of each color by each of the developing devices 46. The toner image of each color on the outer circumferential surface of each of the image holding members 42 is primarily transferred to the outer circumferential surface of the transfer belt 52 by the primary transfer roller 54 facing the image holding member 42.

On the other hand, the paper P is sent out from the paper accommodating section 12 in accordance with a timing at which the toner image of each color which is primarily transferred to the transfer belt 52 reaches the secondary transfer position T1, and is transported to the secondary transfer position T1. The toner image on the transfer belt 52 is secondarily transferred to the paper P which is transported to the secondary transfer position T1 and passes therethrough, by the transfer roller 58.

Subsequently, the paper P having the toner image transferred thereto is transported to the fixing device 18, and the toner image is heated and pressed by the fixing roller 18A and the pressing roller 18B and is fixed onto the paper P. The paper P having the toner image fixed thereto is discharged to the discharge section 20, and the image forming operation is terminated.

Next, the transfer device 200 according to the first exemplary embodiment will be described.

FIG. 2 is a front view illustrating the transfer device 200. As illustrated in FIG. 2, the transfer device 200 includes the above-mentioned transfer roller 58 which is pressed against the transfer belt 52 wound around the driving roller 56. The transfer roller 58 is pressed against the transfer belt 52 to thereby form the nip portion 58A, and transfers a toner image on the transfer belt 52 to the paper P by a transfer voltage, determined from a power supply (not shown), being applied between the transfer roller 58 and the driving roller 56.

In addition, the transfer device 200 includes the above-mentioned transport roller pair 17B as a transporting unit that transports the paper P to a position where the transfer roller 58 and the driving roller 56 face each other. Further, the transfer device 200 includes a guide member 202 as a transporting unit that transports the paper P so that a leading end P1 of the paper P in the transport direction is brought into contact (collision) with a transfer roller 58 side and is then transported into the nip portion 58A during edgeless printing (marginless printing). Here, the wording “edgeless printing (marginless printing)” as used herein refers to transferring a portion of a toner image on the transfer belt 52 to a region including a leading edge of the paper P in the transport direction, that is, refers to printing with no margin which is performed on at least a portion of the leading edge of the paper P in the transport direction.

The guide member 202 includes a pair of guide sections 204 and 206 that guide the paper P. The guide section 204 is disposed on the driving roller 56 side (transfer belt 52 side) with respect to the transport path (transport path 16C in FIG. 1) of the paper P. The guide section 206 is disposed on the transfer roller 58 side with respect to the transport path of the paper P.

The guide section 204 is formed to have a substantially L shape when seen in a front view, and includes a plate shaped portion 204A and a plate shaped portion 204B which is disposed in a direction substantially perpendicular to the plate shaped portion 204A. The plate shaped portion 204A is disposed toward the downstream side of the paper P in the transport direction, and the tip of the plate shaped portion 204A on the downstream side is disposed further toward the transfer roller 58 side than the nip portion 58A. The transport roller pair 17B is disposed obliquely with respect to a horizontal direction so as to send out the paper P toward the plate shaped portion 204A side. The guide section 204 is configured to guide the paper P to the transfer roller 58 side by the paper P, sent out by the transport roller pair 17B, sliding on the surface of the plate shaped portion 204A.

The guide section 206 has a substantially V shape having an obtuse angle when seen in a front view, and includes a plate shaped portion 206A and a plate shaped portion 206B which is disposed in a direction substantially intersecting the plate shaped portion 206A. The plate shaped portion 206A faces the plate shaped portion 204A of the guide section 204 at an interval, and the tip of the plate shaped portion 206A on the downstream side is disposed toward the transfer roller 58 side. In addition, the plate shaped portion 206B is provided at a position facing the plate shaped portion 204A of the guide section 204, and the tip of the plate shaped portion 206B is disposed toward one (one the left side in the drawing) of the transport roller pair 17B. That is, an interval between the plate shaped portion 206B and the plate shaped portion 204A is set to be gradually enlarged toward the transport direction upstream side of the paper P, and thus the paper P is easily transported between the plate shaped portion 206A and the plate shaped portion 204A.

In the guide member 202, the paper P sent out by the transport roller pair 17B is guided to the transfer roller 58 side by sliding on the surface of the plate shaped portion 204A. Thereby, the paper P is transported into the nip portion 58A after the leading end P1 of the paper P is brought into contact with the transfer roller 58 side.

In FIG. 2, a guide member 212 according to a comparative example is indicated by a two-dot chain line. The guide member 212 includes a pair of guide sections 214 and 216. The tip on the downstream side of the guide section 214 disposed on the transfer belt 52 with respect to the transport path of the paper P is disposed toward the transfer belt 52 side (direction of the driving roller 56). In addition, the tip on the downstream side of the guide section 216 disposed on the transfer roller 58 side with respect to the transport path of the paper P is also disposed toward the transfer belt 52 side (direction of the driving roller 56).

The guide member 212 is disposed in printing with a margin in a leading edge of the paper P in the transport direction (margin printing). In the guide member 212, the paper P sent out by the transport roller pair 17B is guided to the transfer belt 52 side by the guide member 212, and is fed into the nip portion 58A after bringing the leading end of the paper P into contact with the transfer belt 52 side.

The guide sections 204 and 206 of the guide member 202 according to the present exemplary embodiment are configured to be more shifted to the transfer roller 58 side along a substantially horizontal direction (slightly obliquely downward direction with respect to the horizontal direction) than the guide sections 214 and 216 of the guide member 212 according to the comparative example. For example, the guide sections 204 and 206 of the guide member 202 are more shifted to the transfer roller 58 side along a substantially horizontal direction (slightly obliquely downward direction with respect to the horizontal direction) at a distance of approximately 0.3 mm to 1.2 mm than the guide sections 214 and 216 of the guide member 212. Meanwhile, in FIG. 2, a positional relationship between the guide member 202 and the guide member 212 are exaggeratedly displayed for ease of understanding. Thereby, the paper P sent out by the transport roller pair 17B is guided to the transfer roller 58 side by the guide member 202, and is transported into the nip portion 58A after bringing the leading end P1 of the paper P into contact with the transfer roller 58 side.

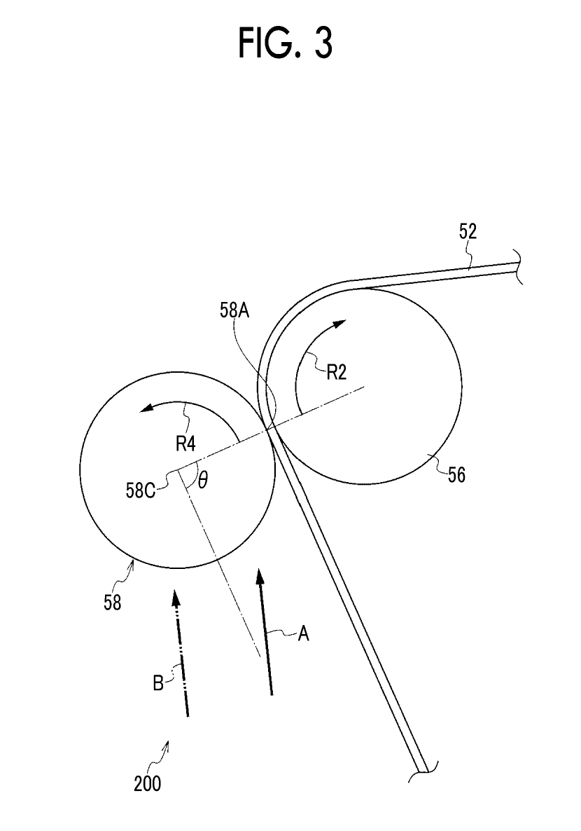

As illustrated in FIG. 3, the guide member 202 is configured to bring the leading end P1 of the paper P into contact (collision) with the nip portion 58A of the transfer roller 58 in a range of up to an angle of 90 degrees on the upstream side of the transfer roller 58 in a rotation direction (see a transport direction of the paper P which is indicated by an arrow A in FIG. 3). In other words, when an angle of the transfer roller 58 on the upstream side in the rotation direction is set to be θ with respect to the nip portion 58A in a center portion 58C of the transfer roller 58, the leading end P1 (see FIG. 2) of the paper P is brought into contact with the nip portion in a range of the angle θ which is greater than 0 and equal to or less than 90 degrees. In the present exemplary embodiment, the paper P is guided from both surfaces of the paper P by the guide sections 204 and 206 (see FIG. 2) of the guide member 202, and thus a contact position of the paper P with the transfer roller 58 is restricted. At this time, a position where the leading end P1 of the paper P is brought into contact with the transfer roller 58 is adjusted by the position of the tip of the guide sections 204 and 206 (see FIG. 2) on the downstream side.

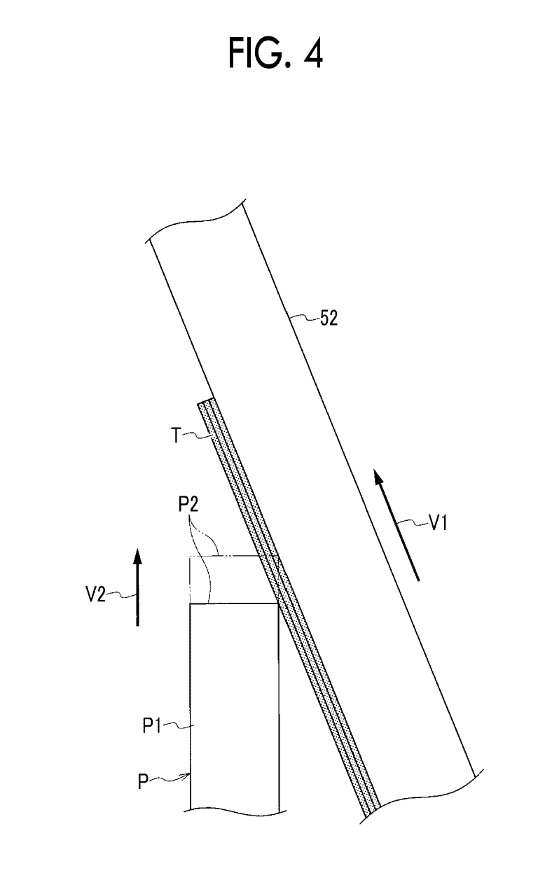

In addition, in the transfer device 200, a peripheral speed ratio of the transfer roller 58 with respect to the transfer belt 52 is set to be in a range of greater than 0.97 to less than 1.00. Here, the wording “peripheral speed ratio of the transfer roller 58 with respect to the transfer belt 52” refers to a value obtained by dividing the peripheral speed of the transfer roller 58 by the peripheral speed of the transfer belt 52. The peripheral speed ratio of the transfer roller 58 with respect to the transfer belt 52 is less than 1.00, and thus a velocity V2 of the paper P becomes lower than a velocity (peripheral speed) V1 of the transfer belt 52 as illustrated in FIG. 4 after the leading end P1 of the paper P comes into contact with the transfer roller 58. Thereby, a tip face P2 of the paper P in the transport direction comes into contact with a toner T on the transfer belt 52 in a state where the velocity V2 of the paper P is lower than the velocity (peripheral speed) V1 of the transfer belt 52. In FIG. 4, the position of the paper P in a case where the velocity V2 of the paper P is equal to the velocity V1 of the transfer belt 52 is indicated by a two-dot chain line.

Next, operations and effects of the transfer device 200 according to the present exemplary embodiment will be described.

As illustrated in FIG. 2, in the transfer device 200, the paper P sent out by the transport roller pair 17B is guided to the transfer roller 58 side by the guide sections 204 and 206 of the guide member 202 during the edgeless printing (when a portion of a toner image on the transfer belt 52 is transferred to a region including a leading edge of the paper P in the transport direction). Thereby, the paper P is transported into the nip portion 58A after the leading end P1 of the paper P comes into contact (collides) with the transfer roller 58 side.

For this reason, in the transfer device 200, it is possible to prevent the tip face P2 of the paper P in the transport direction from scraping off the toner on the transfer belt 52 and to prevent a toner stain from being generated on the tip face P2 of the paper P in the transport direction, compared to a configuration in which the paper P is brought into contact with the transfer belt 52 side and is then transported into the nip portion 58A, like the guide member 212 according to the comparative example.

As illustrated in FIG. 3, in the transfer device 200, the guide member 202 is configured to bring the leading end P1 of the paper P into contact with the nip portion 58A of the transfer roller 58 in a range of up to an angle of 90 degrees on the upstream side of the transfer roller 58 in a rotation direction. In the transfer device 200, it is possible to prevent the paper P from being supplied to a position apart from the nip portion 58A, compared to a configuration in which the leading end P1 of the paper P is brought into contact with a position exceeding an angle of 90 degrees on the upstream side of the transfer roller 58 in the rotation direction.

In addition, in the transfer device 200, a peripheral speed ratio of the transfer roller 58 with respect to the transfer belt 52 is set to be in a range of greater than 0.97 to less than 1.00. In the transfer device 200, the peripheral speed ratio of the transfer roller 58 with respect to the transfer belt 52 is lower than 1.00, and thus the velocity V2 of the paper P becomes lower than the velocity (peripheral speed) V1 of the transfer belt 52 as illustrated in FIG. 4 after the leading end P1 of the paper P comes into contact with the transfer roller 58. Thereby, the tip face P2 of the paper P in the transport direction comes into contact with the toner T on the transfer belt 52 in a state where the velocity V2 of the paper P is lower than the velocity (peripheral speed) V1 of the transfer belt 52. For this reason, in the transfer device 200, it is possible to prevent the tip face P2 of the paper P in the transport direction from scraping off the toner on the transfer belt 52 and to prevent a toner stain from being generated on the tip face P2 of the paper P in the transport direction, compared to a case where the peripheral speed ratio of the transfer roller 58 with respect to the transfer belt 52 is equal to or greater than 1.00.

In addition, when the peripheral speed ratio of the transfer roller 58 with respect to the transfer belt 52 is excessively lowered, there are concerns about the occurrence of image shift, the generation of a toner stain on the surface of the paper P, and the occurrence of image reduction in which an image is reduced. In the transfer device 200, the peripheral speed ratio of the transfer roller 58 with respect to the transfer belt 52 is greater than 0.97. For this reason, when the toner image on the transfer belt 52 is transferred to the paper P, it is possible to suppress the occurrence of image shift, the generation of a toner stain on the surface of the paper P, and the occurrence of image reduction in which an image is reduced, compared to a case where the peripheral speed ratio of the transfer roller 58 with respect to the transfer belt 52 is equal to or less than 0.97.

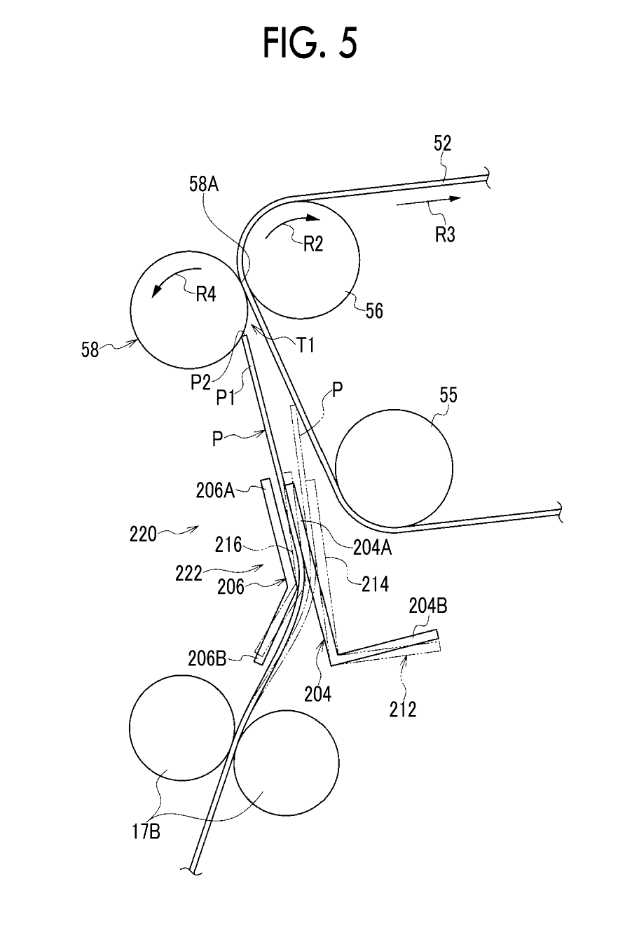

Next, a transfer device according to a second exemplary embodiment of the present invention will be described with reference to FIG. 5. Meanwhile, the same components as those in the first exemplary embodiment described above will be denoted by the same reference numerals and signs, and a description thereof will be omitted here.

As illustrated in FIG. 5, a transfer device 220 includes the transport roller pair 17B as a transporting unit that transports paper P, and a guide member 222 as a transporting unit that transports the paper P so that a leading end P1 of the paper P is brought into contact with the transfer roller 58 side and is then transported into the nip portion 58A during edgeless printing (marginless printing). The guide member 222 includes the pair of guide sections 204 and 206 that guide the paper P. In the guide member 222, an angle of the pair of guide sections 204 and 206 with respect to a horizontal direction is changed with respect to an angle of the pair of guide sections 214 and 216 of the guide member 212 according to a comparative example with respect to the horizontal direction. In more detail, the angle of the pair of guide sections 204 and 206 with respect to the horizontal direction is changed so that a tip of the plate shaped portion 204A on a downstream side and a tip of the plate shaped portion 206A on a downstream side are disposed toward the transfer roller 58 side, compared to the angle of the pair of guide sections 214 and 216 of the guide member 212 according to the comparative example with respect to the horizontal direction.

In the transfer device 220, the paper P sent out by the transport roller pair 17B is guided to the transfer roller 58 side by the guide sections 204 and 206 of the guide member 222 during edgeless printing (when a portion of a toner image on the transfer belt 52 is transferred to a region including a leading edge of the paper P in the transport direction). Thereby, the leading end P1 of the paper P is brought into contact with the transfer roller 58 side and is then transported into the nip portion 58A.

For this reason, in the transfer device 220, it is possible to prevent a tip face P2 of the paper P in the transport direction from scraping off the toner on the transfer belt 52 and to prevent a toner stain from being generated on the tip face P2 of the paper P in the transport direction, compared to a configuration in which the paper P is brought into contact with the transfer belt 52 side and is then transported into the nip portion 58A, like the guide member 212 according to the comparative example.

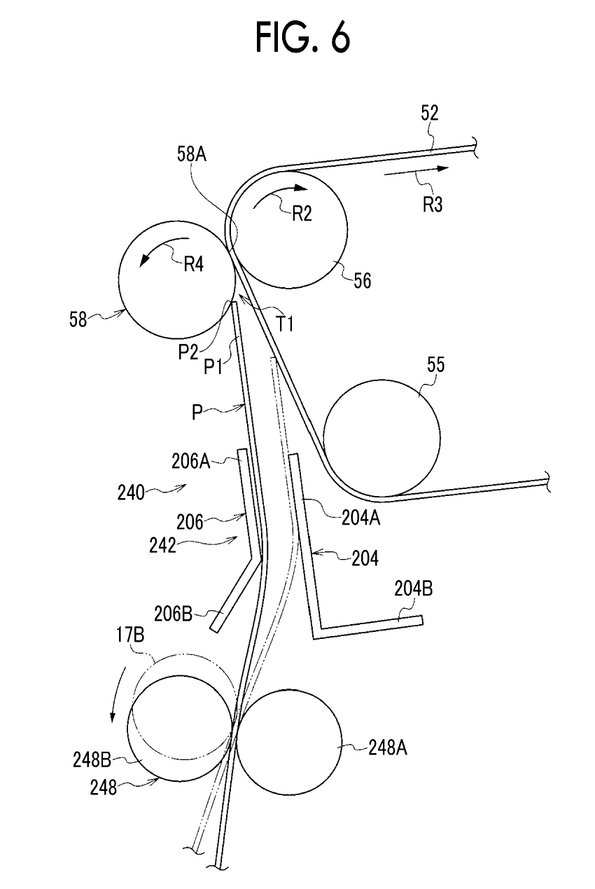

Next, a transfer device according to a third exemplary embodiment of the present invention will be described with reference to FIG. 6. Meanwhile, the same components as those in the first and second exemplary embodiments described above will be denoted by the same reference numerals and signs, and a description thereof will be omitted here.

As illustrated in FIG. 6, a transfer device 240 includes a transport roller pair 248 as a transporting unit that transports the paper P so that a leading end P1 of paper P is brought into contact with the transfer roller 58 side and is then transported into the nip portion 58A during edgeless printing (marginless printing). The transport roller pair 248 includes a transport roller 248A which is disposed on a transfer belt 52 side with respect to a transport path of the paper P, and a transport roller 248B which is disposed on the transfer roller 58 side with respect to the transport path of the paper P. The transport roller pair 248 is configured such that the transport roller 248B disposed on the transfer roller 58 side is more shifted to an upstream side of the paper P in the transport direction than a roller disposed on the transfer roller 58 side in the transport roller pair 17B, compared to the transport roller pair 17B according to the first exemplary embodiment.

In addition, the transfer device 240 includes a guide member 242 which is disposed closer to a downstream side of the paper P in the transport direction than the transport roller pair 248. The guide member 242 includes the pair of guide sections 204 and 206. In the present exemplary embodiment, an interval (distance) between the pair of guide sections 204 and 206 is enlarged in a direction perpendicular to the transport path (guide direction) of the paper P so as not to interfere with the paper P, compared to the guide member 202 according to the first exemplary embodiment. Meanwhile, the guide member 242 is not limited to such a configuration, and may be modified.

In the transfer device 240, the transport roller 248B disposed on the transfer roller 58 side in the transport roller pair 248 is disposed so as to be more shifted to the upstream side of the paper P in the transport direction than the transport roller pair 17B according to the first exemplary embodiment. Thereby, the paper P sent out by the transport roller pair 248 is guided to the transfer roller 58 side during edgeless printing (when a portion of a toner image on the transfer belt 52 is transferred to a region including a leading edge of the paper P in the transport direction). For this reason, the leading end P1 of the paper P is brought into contact with the transfer roller 58 side and is then transported into the nip portion 58A.

In the transfer device 240, it is possible to prevent a tip face P2 of the paper P in the transport direction from scraping off the toner on the transfer belt 52 and to prevent a toner stain from being generated on the tip face P2 of the paper P in the transport direction, compared to a configuration in which the transport roller 248B is not disposed so as to be shifted to the upstream side of the paper P in the transport direction.

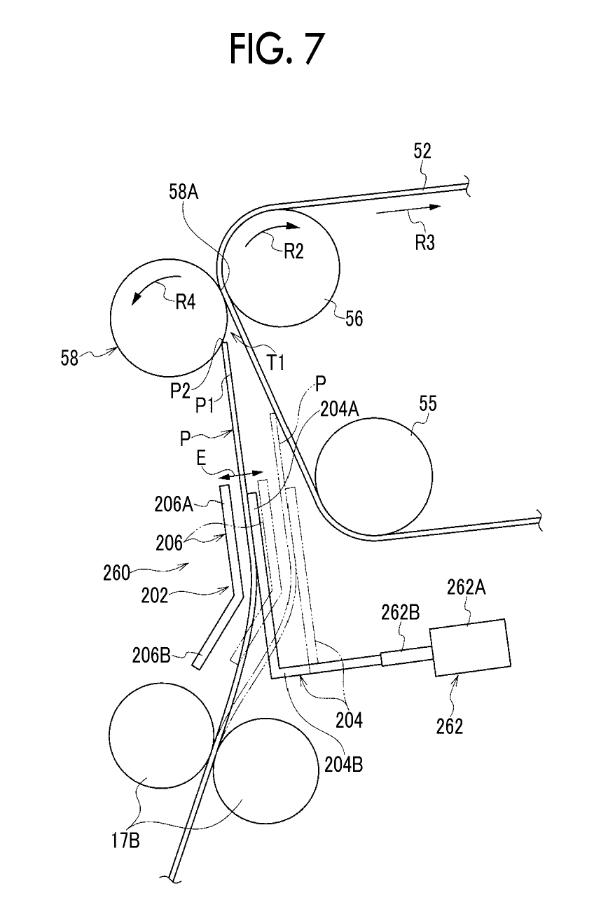

Next, a transfer device according to a fourth exemplary embodiment of the present invention will be described with reference to FIG. 7. Meanwhile, the same components as those in the first to third exemplary embodiments described above will be denoted by the same reference numerals and signs, and a description thereof will be omitted here.

As illustrated in FIG. 7, a transfer device 260 includes the transport roller pair 17B as a transporting unit that transports paper P, the guide member 202 as a transporting unit that transports the paper P so that a leading end P1 of the paper P is brought into contact with the transfer roller 58 side and is then transported into the nip portion 58A during edgeless printing (marginless printing), and a switching device 262 as a switching mechanism that switches between the position of the guide member 202 during the edgeless printing (marginless printing) and the position of the guide member during printing with a margin in a tip portion of the paper P. The guide member 202 includes the pair of guide sections 204 and 206. The switching device 262 is configured to move the guide member 202 in parallel in a direction perpendicular to the plate shaped portion 206A (direction of an arrow E). The switching device 262 is constituted by, for example, a solenoid, and includes a main body portion 262A and a rod 262B which is supported so as to be able to advance to and retreat from the main body portion 262A and is connected to the guide member 202. For example, both ends of the pair of guide sections 204 and 206 in a width direction of the paper P are supported by a bridging portion (not shown), and thus an interval between the guide sections 204 and 206 is maintained constant, and the guide sections 204 and 206 are integrally moved.

In the transfer device 260, the guide member 202 is disposed at a position on the transfer roller 58 side (position where the leading end P1 of the paper P is brought into contact with the transfer roller 58 side) in a movement direction of the guide member 202, as indicated by a solid line in FIG. 7, during edgeless printing (marginless printing). On the other hand, when a toner image on the transfer belt 52 is transferred to a region that does not include a leading edge of the paper P in the transport direction (during printing with a margin in the tip portion of the paper P), the guide member 202 is disposed at a position on the transfer belt 52 side (position where the leading end P1 of the paper P is brought into contact with the transfer belt 52 side) in the movement direction of the guide member 202, as indicated by a two-dot chain line in FIG. 7. The guide member 202 is moved by the switching device 262. The switching device 262 is configured to move the guide member 202 in parallel from the transfer roller 58 side to the transfer belt 52 side or from the transfer belt 52 side to the transfer roller 58 side at a distance of, for example, 0.3 mm to 1.2 mm.

In the transfer device 260, the leading end P1 of the paper P is brought into contact with the transfer roller 58 side and is then transported into the nip portion 58A by the guide member 202, as indicated by the solid line in FIG. 7, during edgeless printing (marginless printing). On the other hand, when the toner image on the transfer belt 52 is transferred to a region that does not include a leading edge of the paper P in the transport direction (during printing with a margin in the tip portion of the paper P), the leading end P1 of the paper P is brought into contact with the transfer belt 52 side and is then transported into the nip portion 58A by the guide member 202, as indicated by the two-dot chain line in FIG. 7. For example, when the guide member 202 is located on the transfer roller 58 side, the switching device 262 moves the guide member 202 to the transfer belt 52 side in parallel, and thus switches the transport direction by the guide member 202 to a direction in which the leading end P1 of the paper P is brought into contact with the transfer belt 52 side. In addition, when the guide member 202 is located on the transfer belt 52 side, the switching device 262 moves the guide member 202 to the transfer roller 58 side in parallel, and thus switches the transport direction by the guide member 202 to a direction in which the leading end P1 of the paper P is brought into contact with the transfer roller 58 side.

In the transfer device 260, it is possible to suppress the occurrence of image shift to the paper P when the toner image on the transfer belt 52 is transferred to a region that does not include a leading edge of the paper P in the transport direction (during printing with a margin in the tip portion of the paper P), compared to a configuration without the switching device 262.

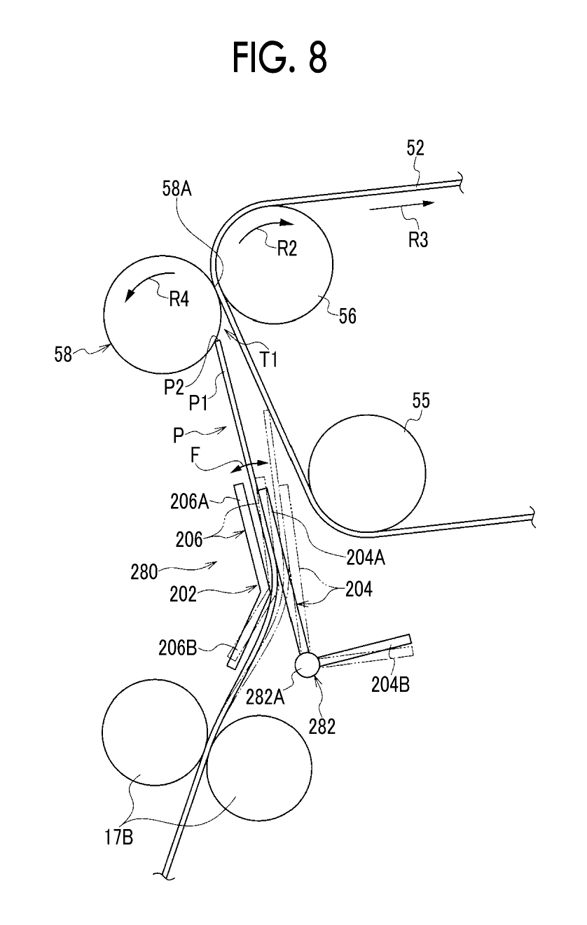

Next, a transfer device according to a fifth exemplary embodiment of the present invention will be described with reference to FIG. 8. Meanwhile, the same components as those in the first to fourth exemplary embodiments described above will be denoted by the same reference numerals and signs, and a description thereof will be omitted here.

As illustrated in FIG. 8, a transfer device 280 includes the transport roller pair 17B as a transporting unit that transports paper P, the guide member 202 as a transporting unit that transports the paper P so that a leading end P1 of the paper P is brought into contact with the transfer roller 58 side and is then transported into the nip portion 58A during edgeless printing (marginless printing), and a switching device 282 as a switching mechanism that switches between the position of the guide member 202 during the edgeless printing (marginless printing) and the position of the guide member during printing with a margin in a tip portion of the paper P. The switching device 282 is configured to change the angle of the pair of guide sections 204 and 206 with respect to a horizontal direction by integrally rotating the guide member 202. In the present exemplary embodiment, the switching device 282 includes a motor 282A that rotates the guide member 202 in a direction of an arrow F centering on a corner portion of the guide section 204.

In the transfer device 280, the orientation of the tip of the pair of guide sections 204 and 206 of the guide member 202 on a downstream side is disposed in a direction in which the leading end P1 of the paper P is brought into contact with the transfer roller 58 side, as indicated by a solid line in FIG. 8, during edgeless printing (marginless printing). On the other hand, when a toner image on the transfer belt 52 is transferred to a region that does not include a leading edge of the paper P in the transport direction (during printing with a margin in the tip portion of the paper P), the orientation of the tip of the pair of guide sections 204 and 206 of the guide member 202 on the downstream side is disposed in a direction in which the leading end P1 of the paper P is brought into contact with the transfer belt 52 side, as indicated by a two-dot chain line in FIG. 8. The switching device 282 rotates the guide member 202 so that the orientation of the tip of the pair of guide sections 204 and 206 of the guide member 202 on the downstream side faces the transfer belt 52 side or the transfer roller 58 side.

In the transfer device 280, the leading end P1 of the paper P is brought into contact with the transfer roller 58 side and is then transported into the nip portion 58A by the guide member 202, as indicated by the solid line in FIG. 8, during edgeless printing (marginless printing). On the other hand, when the toner image on the transfer belt 52 is transferred to a region that does not include a leading edge of the paper P in the transport direction (during printing with a margin in the tip portion of the paper P), the leading end P1 of the paper P is brought into contact with the transfer belt 52 side and is then transported into the nip portion 58A as indicated by the two-dot chain line in FIG. 8. For example, when the tip of the pair of guide sections 204 and 206 of the guide member 202 on the downstream side faces the transfer roller 58 side, the switching device 282 rotates the tip of the pair of guide sections 204 and 206 of the guide member 202 to the transfer belt 52 side to thereby switch the transport direction by the guide member 202 to a direction in which the leading end P1 of the paper P is brought into contact with the transfer belt 52 side. In addition, when the tip of the pair of guide sections 204 and 206 of the guide member 202 on the downstream side faces the transfer belt 52 side, the switching device 282 rotates the tip of the pair of guide sections 204 and 206 of the guide member 202 on the downstream side to the transfer roller 58 side to thereby switch the transport direction by the guide member 202 to a direction in which the leading end P1 of the paper P is brought into contact with the transfer roller 58 side.

In the transfer device 280, it is possible to suppress the occurrence of image shift to the paper P when the toner image on the transfer belt 52 is transferred to a region that does not include a leading edge of the paper P in the transport direction (during printing with a margin in the tip portion of the paper P), compared to a configuration without the switching device 282.

Meanwhile, the transfer device of the present invention is not limited to the transfer devices described in the first to fifth exemplary embodiments. For example, the peripheral speed of a roller on the transfer roller 58 side in the transport roller pair 17B as a transporting unit may be made higher than the peripheral speed of a roller on the transfer belt 52 side during edgeless printing (marginless printing) so that the leading end P1 of the paper P is brought into contact with the transfer roller 58 side.

In addition, in the transfer device of the present invention, when the toner image on the transfer belt 52 is transferred to a region that does not include a leading edge of the paper P in the transport direction (during printing with a margin in the tip portion of the paper P), a configuration may be adopted which includes a switching mechanism for changing the peripheral speed of a roller on the transfer roller 58 side in the transport roller pair 17B as a transporting unit and the peripheral speed of a roller on the transfer belt 52 side to the same speed.

In addition, in the transfer devices according to the fourth and fifth exemplary embodiments, the configurations of the switching devices 262 and 282 are not limited to the configurations according to the exemplary embodiments, and may be modified to a configuration with another mechanism that moves or rotates the guide member 202. In addition, a direction in which the guide member 202 is moved by the switching device 262 is not limited to the direction of the arrow E in the fourth exemplary embodiment, and may be modified to another direction.

In addition, in the transfer device according to the fifth exemplary embodiment, the guide member 202 is rotated centering on the corner portion of the guide section 204 of the guide member 202. However, the present invention is not limited thereto, and the guide member 202 may be configured to be rotated centering on another position of the guide member 202.

### Example

Next, a description will be given of an experiment in which a stain on a tip face P2 of paper P in a transport direction is evaluated using a transfer device 300 which is an experimental device.

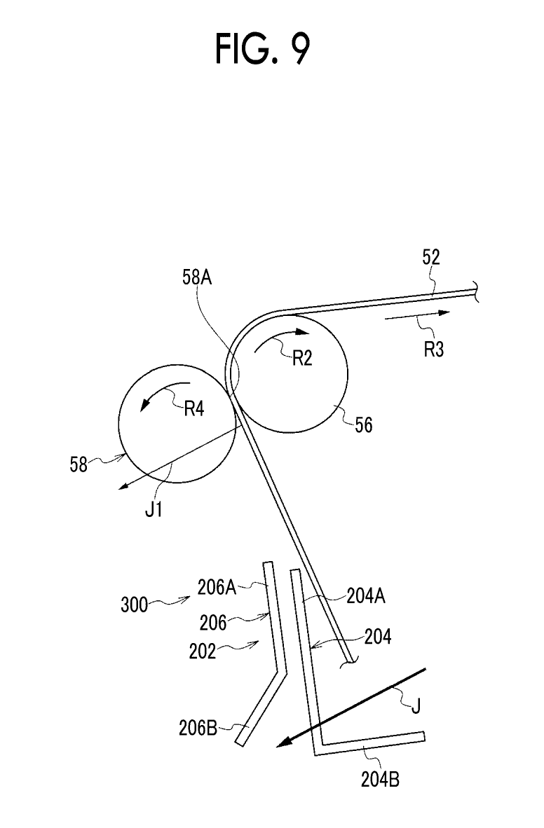

FIG. 9 illustrates the transfer device 300 which is an experimental device. As illustrated in FIG. 9, the transfer device 300 includes the guide member 202 constituted by the pair of guide sections 204 and 206. The guide member 202 is set to move in a direction intersecting a horizontal direction (direction of an arrow J), that is, to move downward in parallel as moving to the transfer roller 58 side from the transfer belt 52. DocuCentre-V C7775 made by Fuji Xerox Corp. is used as an image forming apparatus including the transfer device 300. In addition, Ncolor209 (made by Fuji Zerox InterField Co., Ltd.) is used as the paper P, and the transport velocity of the paper P is set to 175 mm/s. In addition, a diameter φ of the transfer roller 58 is 17.2 cm, a diameter φ of the driving roller 56 is 18.0 cm, and the center of the driving roller 56 is offset by 10 degrees with respect to the center of the transfer roller 58 from the position thereof in a horizontal direction. In addition, the temperature is 28° C., the humidity (relative humidity) is 85%, image concentration is 240%. In the image forming apparatus including the transfer device 300, an image is formed on the paper P by edgeless printing (marginless printing).

In addition, the transfer device 300 has a configuration in which the guide member 202 is moved in parallel in the direction of the arrow J (direction on the transfer roller 58 side which is perpendicular to the transfer belt 52) from the position on the transfer belt 52 side illustrated in FIG. 9. The guide member 202 moves in parallel in the direction of the arrow J, and thus a contact position of the tip (leading end) of the paper P moves in a direction of an arrow J1. In this experiment, the position of the tip of the paper P coming into contact with the transfer belt 52 illustrated in FIG. 9 is set to 0 mm, and a distance (mm) at which the contact position of the tip of the paper P is moved in the direction of the arrow J1 from the position and a toner stain on the tip face of the paper P in the transport direction at the distance are measured.

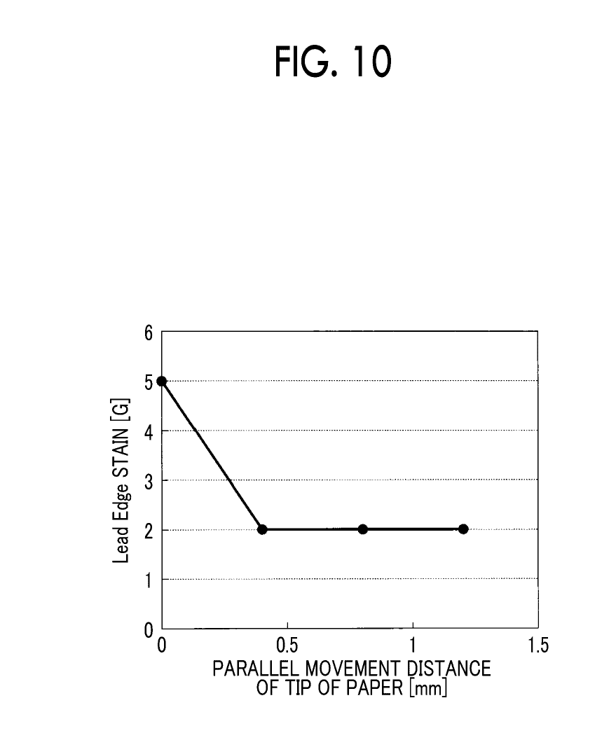

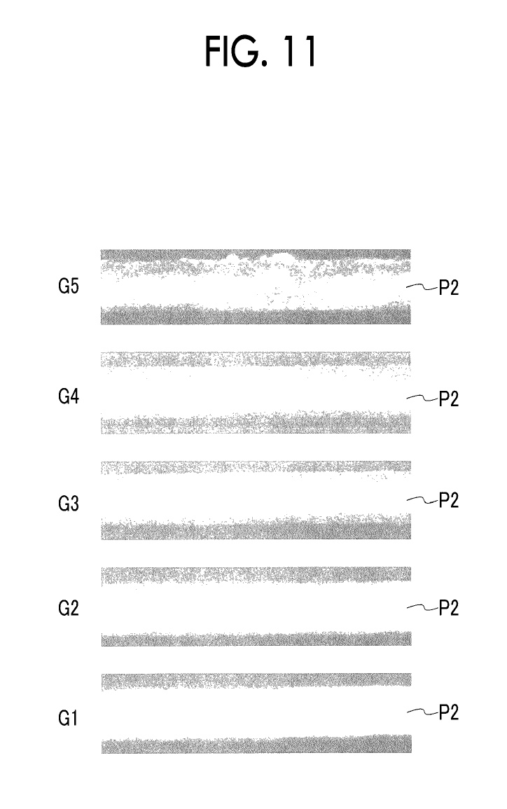

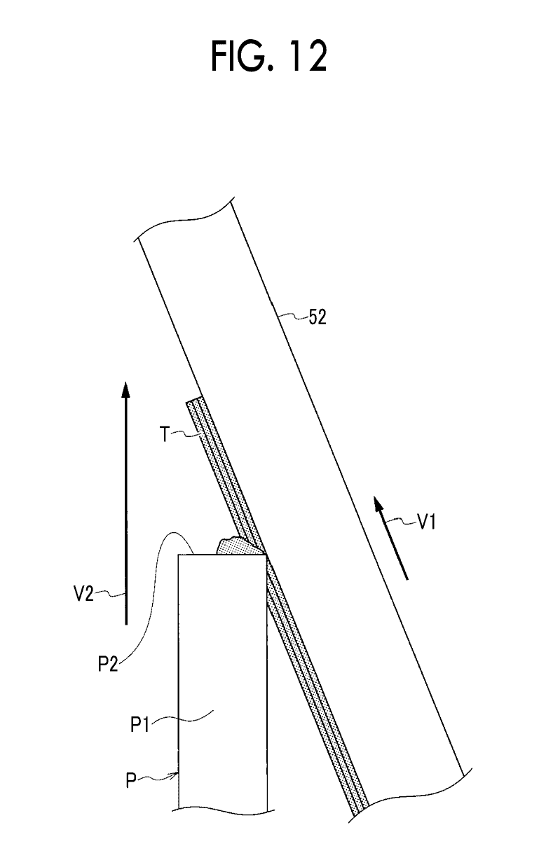

FIG. 10 is a graph illustrating a relationship between a parallel movement distance (see FIG. 9) of a contact position of the tip of paper P in the direction of the arrow J1 and a toner stain G on a tip face (see a tip face P2 in FIG. 12) of the paper P in a transport direction in the transfer device 300. FIG. 11 illustrates states of a toner stain on the tip face P2 of the paper P in the transport direction which are indicated by G1 to G5 in a stepwise manner. As illustrated in FIG. 11, G1 indicates a state where the amount of toner stain is the smallest, and the amount of toner stain increases as the state transitions from G2 to G5. As illustrated in FIG. 10, when the parallel movement distance of the contact position of the tip of the paper P in the direction of the arrow J1 is in a range of 0.3 mm to 1.2 mm, the toner stain on the tip face P2 of the paper P in the transport direction is G2, which indicates that the amount of toner stain is smaller than that in a case where the parallel movement distance of the contact position of the tip of the paper Pin the direction of the arrow J1 is less than 0.3 mm. In the transfer device 300, when the parallel movement distance of the contact position of the tip of the paper P in the direction of the arrow J1 is equal to or greater than 0.3 mm, it is confirmed that the tip of the paper P comes into contact with the transfer roller 58 side.

FIG. 12 illustrates a state of a toner T in a case where a velocity (peripheral speed) V1 of the transfer belt 52 is lower than a velocity V2 of the paper P. FIG. 12 schematically illustrates a case where the tip (leading end) of the paper P comes into contact with the transfer belt 52 in the vicinity of the nip portion 58A. As illustrated in FIG. 12, when the velocity V1 of the transfer belt 52 is lower than the velocity V2 of the paper P and when the velocity V1 of the transfer belt 52 is equal to the velocity V2 of the paper P, there is a higher possibility that the toner T on the transfer belt 52 is scraped off by the tip face P2 of the paper P in the transport direction and that a toner stain is generated on the tip face P2 of the paper P in the transport direction than a case where the velocity V1 of the transfer belt 52 is higher than the velocity V2 of the paper P (see FIG. 4).

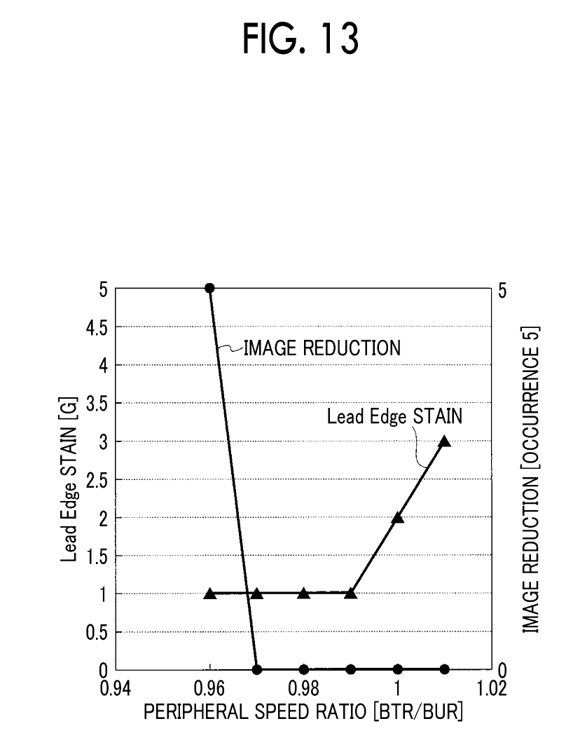

In FIG. 13, a relationship between a peripheral speed ratio of the transfer roller 58 with respect to the driving roller 56 and a toner stain G on the tip face P2 of the paper P in the transport direction is illustrated by a graph. In addition, in FIG. 13, a relationship between a peripheral speed ratio of the transfer roller 58 with respect to the driving roller 56 and the occurrence of image reduction of a toner image transferred to the paper P is illustrated by a graph. In FIG. 13, an experiment for transferring a toner image on the transfer belt 52 to the paper P is performed in a state where the position of the guide member 202 (see FIG. 9) is moved by 0.5 mm in the direction of the arrow J. In a vertical axis on the right side of FIG. 13, a case where image reduction occurs is indicated by “5”, and a case where image reduction does not occur is indicated by “0”.

As illustrated in FIG. 13, when the peripheral speed ratio of the transfer roller 58 (BTR) with respect to the driving roller 56 (BUR) is less than 1.00, the velocity V2 of the paper P becomes lower than the velocity V1 of the transfer belt 52 which is driven by the driving roller 56. When the peripheral speed ratio of the transfer roller 58 with respect to the driving roller 56 is less than 1.00, a toner stain is in a range between G2 and G1, and thus it may be understood that a little toner stain is generated on the tip face P2 of the paper P in the transport direction. For this reason, when the velocity V2 of the paper P is lower than the velocity V1 of the transfer belt 52, it is possible to prevent the toner T on the transfer belt 52 from being scraped off by the tip face P2 of the paper P in the transport direction and to prevent a toner stain from being generated on the tip face P2 of the paper P in the transport direction, compared to a case where the velocity V2 of the paper P is equal to or higher than the velocity V1 of the transfer belt 52.

In addition, as illustrated in FIG. 13, when the peripheral speed ratio of the transfer roller 58 with respect to the driving roller 56 is less than 0.97, image reduction of an image of the paper P occurs (portion of “5” in FIG. 13). For this reason, it is preferable that the peripheral speed ratio of the transfer roller 58 with respect to the driving roller 56 (the transfer belt 52 driven by the driving roller 56) is greater than 0.97 and is less than 1.00.

Although the present invention has been described so far in detail with reference to specific exemplary embodiments, it will be obvious to those skilled in the art that various changes and modifications may be made without departing from the spirit and the scope of the present invention.

Meanwhile, the transfer device of the present invention is configured such that a toner image on the transfer belt 52 is secondarily transferred to the paper P. However, the present invention is not limited thereto, and may also be applied to, for example, a configuration in which a toner image on an image holding member such as a photoreceptor drum is transferred to a recording medium such as paper.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A transfer device comprising:
a transfer roller that forms a nip portion between the transfer roller and an image holding member and transfers a toner image on the image holding member to a recording medium; and
a transporting unit that transports the recording medium so that a leading end of the recording medium in a transport direction is brought into contact with the transfer roller and is then transported into the nip portion, when a portion of the toner image on the image holding member is transferred to a region that includes a leading edge of the recording medium in the transport direction.

2. The transfer device according to claim 1, wherein the transporting unit brings the leading end of the recording medium into contact with the nip portion of the transfer roller in a range of up to 90 degrees on an upstream side of the transfer roller in a rotation direction.

3. The transfer device according to claim 1, wherein a peripheral speed ratio of the transfer roller with respect to the image holding member is set to be in a range of greater than 0.97 to less than 1.00.

4. The transfer device according to claim 2, wherein a peripheral speed ratio of the transfer roller with respect to the image holding member is set to be in a range of greater than 0.97 to less than 1.00.

5. The transfer device according to claim 1,
wherein when the portion of the toner image on the image holding member is transferred to the region that includes the leading edge of the recording medium, the leading end of the recording medium is brought into contact with the transfer roller and is then transported into the nip portion by the transporting unit, and
wherein when the toner image on the image holding member is transferred to a region that does not include the leading edge of the recording medium, a switching mechanism that switches the transport direction by the transporting unit to a direction in which the leading end of the recording medium is brought into contact with the image holding member side is provided.

6. The transfer device according to claim 2,
wherein when the portion of the toner image on the image holding member is transferred to the region that includes the leading edge of the recording medium, the leading end of the recording medium is brought into contact with the transfer roller and is then transported into the nip portion by the transporting unit, and
wherein when the toner image on the image holding member is transferred to a region that does not include the leading edge of the recording medium, a switching mechanism that switches the transport direction by the transporting unit to a direction in which the leading end of the recording medium ∘ is brought into contact with the image holding member.

7. The transfer device according to claim 3,
wherein when the portion of the toner image on the image holding member is transferred to the region that includes the leading edge of the recording medium, the leading end of the recording medium is brought into contact with the transfer roller and is then transported into the nip portion by the transporting unit, and
wherein when the toner image on the image holding member is transferred to a region that does not include the leading edge of the recording medium, a switching mechanism that switches the transport direction by the transporting unit to a direction in which the leading end of the recording medium is brought into contact with the image holding member.

8. The transfer device according to claim 4,
wherein when the portion of the toner image on the image holding member is transferred to the region that includes the leading edge of the recording medium, the leading end of the recording medium is brought into contact with the transfer roller and is then transported into the nip portion by the transporting unit, and
wherein when the toner image on the image holding member is transferred to a region that does not include the leading edge of the recording medium, a switching mechanism that switches the transport direction by the transporting unit to a direction in which the leading end of the recording medium is brought into contact with the image holding member.

9. An image forming apparatus comprising:
an image holding member that holds a toner image; and
the transfer device according to claim 1.

10. An image forming apparatus comprising:
an image holding member that holds a toner image; and
the transfer device according to claim 2.
